(19) United States
(12) Patent Application Publication
(10) Pub. No.: US 2001/0021692 A1
(43) Pub. Date: Sep. 13, 2001

(54) Method of stabilising fabric softening compositions

(76) Inventors: Mansur Sultan Mohammadi, Merseyside (GB); Janice Elaine Wright, Merseyside (GB); Kevin Anthony Ormandy, Merseyside (GB); Adam Matthew Briggs, Merseyside (GB)

Correspondence Address: UNILEVER, PATENT DEPARTMENT, 45 RIVER ROAD, EDGEWATER, NJ, 07020, US

(21) Appl. No.: 09/741,378

(22) Filed: Dec. 20, 2000

(30) Foreign Application Priority Data
Dec. 22, 1999 (GB) 9930436.2

(51) Int. Cl. C11D 3/00; D06L 1/00

(52) U.S. Cl. 510/515; 510/391

(57) ABSTRACT

The invention provides a method of improving the viscosity stability upon storage of a fabric softening composition comprising:

(a) 0.5% to 30% by weight of at least one ester-linked quaternary ammonium fabric softening compound,

(b) perfume, and

(c) an alkoxylated nonionic surfactant,

by the inclusion in the composition of at least one oily sugar derivative in a weight ratio of softening compound to sugar derivative in the range 30:1 to 1:1.

Also provided are a fabric softening composition produced by the method of the invention, a method of treating fabric by applying thereto said composition and the use of a particular oily sugar derivatives to provide viscosity stability at 37° C. to a fabric softening composition comprising 0.5% to 30% by weight of at least one ester-linked quaternary ammonium fabric softening compound, a perfume and an alkoxylated nonionic surfactant.

### TECHNICAL FIELD

The present invention relates to a method of stabilising fabric softening compositions, in particular, to a method of providing storage stability across a range of temperatures in concentrated fabric softening compositions comprising at least one ester-linked quaternary ammonium fabric softening compound, a perfume and an alkoxylated nonionic surfactant. The invention also relates to the compositions produced by the method, to a method of treating clothes with the compositions and to the use of certain oily sugar derivatives to stabilise said compositions.

### BACKGROUND AND PRIOR ART

Fabric softener compositions, especially those added in the rinse, are well known. Typically, these compositions comprise a cationic fabric softening agent, a perfume and a nonionic surfactant. However, frequently such compositions suffer from problems with physical stability during storage, especially, if the nonionic surfactant is an alkoxylated nonionic surfactant. The compositions may suffer from viscosity fluctuations/instability during storage, and/or changes in appearance.

These viscosity instability problems, are particularly apparent in concentrated fabric softener compositions comprising ester-linked quaternary ammonium fabric softening compounds, a perfume and an alkoxylated, particularly an ethoxylated, nonionic surfactant. For example, the product may thicken to the point where it cannot be poured from the bottle. The problem is most pronounced at elevated temperatures, e.g. 37° C. and above.

However the prior art methods of providing stability by the addition of oils such as mineral oils and ester oils, whilst providing some degree of stability (e.g. octyl stearate, decane) require the oils to be added in addition to the required amount of the cationic fabric softening compound if the softening performance of the composition is to be maintained. This is because mineral oils and non-sugar ester oils are poor softening compounds in themselves. This method is disclosed in EP 845 523 (Givaudan).

Oily sugar derivatives are known as fabric softener compositions. WO 98/16538 (Unilever) discloses fabric softening compositions comprising liquid or soft solid derivatives of a cyclic polyol or a reduced saccharide which give good softening and retain absorbency of the fabric.

Our co-pending UK patent application GB 9911437.3 discloses fabric softening compositions comprising liquid or soft solid derivatives of a cyclic polyol or a reduced saccharide, at least one anionic surfactant, and at least one cationic polymer.

Our co-pending UK patent application GB 9911434.0 discloses fabric softening compositions comprising a liquid or soft solid derivative of a cyclic polyol or a reduced saccharide, the derivatives having at least one unsaturated bond in the alkyl or alkenyl chains, a deposition aid and one or more antioxidants.

WO 96/15213 (Henkel) discloses textile softening agents containing alkyl, alkenyl and/or acyl group containing sugar derivatives, which are solid after esterification, in combination with nonionic and cationic emulsifiers.

The present invention is directed towards alleviating the above problems, and in particular to providing fabric softening compositions which exhibit good viscosity stability across a range of temperatures whilst maintaining softening performance and cost-effectiveness.

The principal advantages of the invention include that the viscosity stability upon storage at elevated temperatures of certain concentrated fabric softening compositions is improved in a cost-effective manner. The oily sugar derivatives described herein have been found, surprisingly, to provide better stabilisation effects than the non-sugar ester oils which have been suggested in the art.

Thus according to the invention some of the ester-linked quaternary ammonium fabric softening compound in the composition can be replaced by the oily sugar derivative without loss of softening performance whilst providing a composition which has improved viscosity stability upon storage. This has a further advantage that the same level of softening performance can be obtained from a lower concentration of said softener compound.

### DEFINITION OF THE INVENTION

Thus according to one aspect of the invention there is provided a method of improving the viscosity stability upon storage of a fabric softening composition comprising:

(a) 0.5% to 30% by weight of at least one ester-linked quaternary ammonium fabric softening compound,

(b) perfume, and

(c) an alkoxylated nonionic surfactant,

by the inclusion in the composition of at least one oily sugar derivative in a weight ratio of softening compound to sugar derivative in the range from 30:1 to 1:1.

The alkoxylated nonionic surfactant is preferably an ethoxylated surfactant.

It has been found, surprisingly, that this method provides an unexpected improvement in the elevated temperature storage stability, and viscosity stability, of the compositions produced. In particular good results are obtained at 37° C. which is the standard temperature for testing elevated temperature storage stability. Also appearance of the compositions after storage is improved (pearlescence and striations are less noticeable).

According to a further aspect the present invention also provides a fabric softening composition produced by the method of the invention.

According to a further aspect the present invention also provides a method of treating fabrics with the above

compositions. According to a further aspect the present invention also provides the use of an oily sugar derivative as defined herein to provide viscosity stability at 37° C. to a fabric softening composition comprising 0.5% to 30% by weight of at least one ester-linked quaternary ammonium fabric softening compound, a perfume and an alkoxylated nonionic surfactant.

### DETAILED DESCRIPTION OF THE INVENTION

Method

The method of the invention may be carried out by manufacturing the compositions in any suitable manner so as to provide the viscosity stabilisation effect.

Although viscosity stability of compositions can be achieved by directly co-melting together the softening compound and the oily sugar derivative as is conventional in the art, it is preferred that the compositions are not prepared in this manner.

It is especially preferred that the compositions are prepared by a method that includes the step wherein the softening compound and/or the oily sugar derivative is/are separately mixed with another active component of the fabric softening composition to form a pre-mixture prior to the admixing of the softening compound with the oily sugar derivative to produce the fabric softening composition.

The pre-mixing with another active component to form a pre-mixture prior to said admixing may also apply to both the softening compound and the oily sugar derivative.

The term “active component” as used herein defines a component of the compositions which has a functional role therein and which is supplied as a separate raw material product. The term includes nonionic and cationic surfactants and perfumes. The term does not include water, dyes, preservatives or any of the minor optional ingredients recited below. Preferably both the derivative and the softening compound are pre-mixed in this manner.

The active component is preferably a cationic surfactant having a single C₈-C₂₈ alkyl or alkenyl chain, a nonionic surfactant or a perfume. The nonionic surfactant referred to here may be either the essential alkoxylated nonionic surfactant or a non-alkoxylated surfactant.

However, the term “active component” does not include where a component raw material is supplied with a minor amount of an “active component” included as part of that raw material as obtained from the manufacturer. Thus, for example, a cationic fabric softening compound raw material (supplied as comprising a minor amount of a surfactant) mixed directly with an oily sugar derivative raw material in the absence of another “active component” raw material as defined above would not form part of the preferred method.

The separate pre-mixing of the softening compound and/or the oily sugar derivative with another active component of the fabric softening composition to form said pre-mixture may occur in any known manner.

The method may incorporate one or more of the following ways of forming the pre-mixture(s).

According to one preferred method the oily sugar derivative is pre-mixed with water and/or with at least one cationic surfactant having a single C₈-C₂₈ alkyl or alkenyl chain, and/or nonionic surfactant, to form a pre-mixture and subsequently the softening compound, in at least partially liquid or molten state, is mixed with said pre-mixture.

For this method it is especially preferred that the oily sugar derivative is pre-mixed with at least one cationic surfactant(as defined above) either alone or in the presence of water.

For this method, the pre-mixture formed from the oily sugar derivative is preferably at a temperature of at least 30° C., preferably at least 40° C., most preferably at least 50° C., when the softening compound is mixed therewith. However the resultant mixture obtained from the pre-mixture and the softening compound being mixed together may subsequently be heated to said temperature.

According to another preferred method, the softening compound is pre-mixed with water and/or with at least one cationic surfactant having a single C₈-C₂₈ alkyl or alkenyl chain, and/or a nonionic surfactant, to form a pre-mixture and subsequently the oily sugar derivative is mixed with said pre-mixture.

For this method it is especially preferred that the softening compound is pre-mixed with at least one nonionic surfactant either alone or in the presence of water.

It is especially preferred that if optional minor ingredients which are polyelectrolytes are present, such as preservative, these are added after the oily sugar derivatives and the softening compound have been brought into contact. If these components are added before this occurs then the compositions may not be stable and/or complexation of the oily sugar derivatives and the softening compound may occur.

Ingredients

The ester-linked quaternary ammonium fabric softening compound

The ester-linked quaternary ammonium fabric softening compound is herein referred to as “the softening compound”.

The ester-linked quaternary ammonium compound preferably has two or more, e.g. three, C₈₋₂₈ alkyl or alkenyl chains connected to a nitrogen atom via at least one ester link. Such ester compounds having two or more ester linkages are the most preferred.

Especially suitable compounds have two or more alkyl or alkenyl chains each having an average chain length equal to, or greater than C₁₄, more preferably, equal to or greater C₁₆. Most preferably at least 50% of the total number of alkyl or alkenyl chains have a chain length equal to, or greater than C₁₈.

It is advantageous for environmental reasons if the ester-linked quaternary ammonium compound is biologically degradable. It is also preferred if the alkyl or alkenyl chains of the ester-linked quaternary ammonium compound are predominantly linear.

The most preferred type of ester-linked quaternary ammonium material is represented by formula (I):

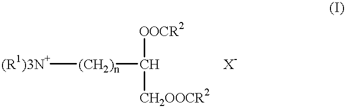

wherein each R¹ group is independently selected from C₁₋₄, especially C₂₋₃, alkyl or hydroxyalkyl or C₂₋₄ alkenyl groups; and wherein each R² group is independently selected from C₈₋₂₈ alkyl or alkenyl groups; X⁻ is any suitable anion including a halide, acetate or lower alkosulfate ion, such as chloride or methosulphate, and n is 0 or an integer from, 1-5.

Preferred materials of this class such as 1,2 bis[hardened tallowoyloxy]-3-trimethylammonium propane chloride and their method of preparation are, for example, described in U.S. Pat. No. 4,137,180 (Lever Brothers). Preferably these materials comprise small amounts of the corresponding monoester as described in U.S. Pat. No. 4,137,180 for example 1-hardened tallowoyloxy-2-hydroxy 3-trimethylammonium propane chloride.

A second type of ester-linked quaternary ammonium material is represented by the formula (II):

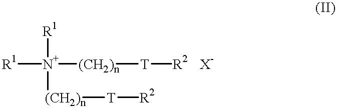

Wherein T is

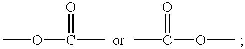

and R¹, R², n, and X⁻ are as defined above.

In this class di(tallowoyloxyethyl) dimethyl ammonium chloride and methyl bis-[ethyl (tallowoyl)]-2-hydroxyethyl ammonium methyl sulphate are especially preferred.

A third preferred type of ester-linked quaternary ammonium material for use as the cationic fabric softening compound is represented by formula (III):

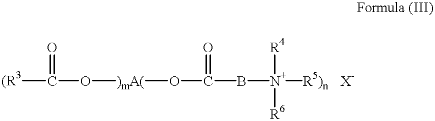

wherein X⁻ is as defined above, A is an (m+n) valent radical remaining after the removal of (m+n) hydroxy groups from an aliphatic polyol having p hydroxy groups and an atomic ratio of carbon to oxygen in the range of 1.0 to 3.0 and up to 2 groups per hydroxy group selected from ethylene oxide and propylene oxide, m is 0 or an integer from 1 to p-n, n is an integer from 1 to p-m, and p is an integer of at least 2, B is an alkylene or alkylidene group containing 1 to 4 carbon atoms, R³, R⁴, R⁵ and R⁶ are, independently from each other, straight or branched chain C₁-C₄₈ alkyl or alkenyl groups, optionally with substitution by one or more functional groups and/or interruption by at most 10 ethylene oxide and/or propylene oxide groups, or by at most two functional groups selected from

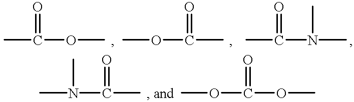

or R⁴ and R⁵ may form a ring system containing 5 or 6 atoms in the ring, with the proviso that the average compound either has at least one R group having 22-48 carbon atoms, or at least two R groups having 16-20 carbon atoms, or at least three R groups having 10-14 carbon atoms. Preferred compounds of this type are described in EP 638 639 (Akzo).

The compositions comprise between 0.5% wt-30% wt of the quaternary ammonium fabric softening compound, preferably 8%-25%, more preferably 9-20%, most preferably 10%-15%, based on the total weight of the composition.

Perfume

The perfume may be any perfume conventionally used in fabric softening compositions. The perfume will thus preferably be comparable with the types fabric softening actives typically found in fabric softening compositions, although, not many commercially available perfumes will not be compatible. Also the perfume will generally be polar in nature.

The perfume used in the invention may be lipophilic in nature. By a lipophilic perfume is meant that the perfume has a solubility in water (i.e. it dissolves) of 1 g or less in 100 ml of water at 20° C. Preferably solubility in water is 0.5 g or less, preferably 0.3 g or less. Such perfumes may be referred to as water-insoluble perfumes.

Perfumes contain a number of ingredients which may be natural products or extracts such as essential oils, absolutes, resinoids, resins etc. and synthetic perfume components such as hydrocarbons, alcohols, aldehydes, ketones ethers, acids, esters, acetals, ketals, nitrites, phenols, etc. including saturated and unsaturated compounds, aliphatic, alicyclic, heterocyclic and aromatic compounds. Examples of such perfume components are to be found in “Perfume and Flavour Chemicals” by Steffen Arctander (Library of Congress catalogue card no. 75-91398).

Nonionic Surfactant

The compositions comprise one or more alkoxylated nonionic surfactants. Preferably the nonionic surfactant has a single C₈-C₂₈ alkyl or alkenyl chain, most preferably a single C₈-C₂₀ alkyl or alkenyl chain, more preferably a single C₁₀-C₁₈ alkyl or alkenyl chain. The preferred alkoylate is the ethoxlylate.

Suitable nonionic surfactants include the condensation products of C₈-C₃₀ primary or secondary linear or branched alcohols preferably C₁₀-C₂₂ alcohols, alkoxylated with 10 or more moles of alkylene oxide, preferably 10-25 moles of alkylene oxide, more preferably between 15 and 20 moles of alkylene oxide. Preferably the alkylene oxide is ethylene oxide although it may be/include propoxylate groups. The alcohols may be saturated or unsaturated.

Suitable alcohol ethoxylates include the condensation products of coconut fatty alcohol with 15-20 moles of ethylene oxide, e.g. coco 20 ethoxylate, and, condensation products of tallow alcohol with 10-20 moles of ethylene oxide, e.g. tallow 15 ethoxylate. Ethoxylated sorbitans are also suitable.

The alkoxylated nonionic surfactant preferably has an HLB of from about 15 to about 20.

Other non-alkoxylated nonionic surfactants such as alkyl poly glucosides may also be present in addition to the alkoxylated nonionic surfactant.

The nonionic surfactant is typically present in an amount of 0.01 to 5% by weight, preferably 0.05%-3%, more preferably 0.1%-2% based on the total weight of the composition.

Oily Sugar Derivative

The oily sugar derivative is a liquid or soft solid derivative of a cyclic polyol or of a reduced saccharide, said derivative resulting from 35 to 100% of the hydroxyl groups in said polyol or in said saccharide being esterified or etherified. The derivative has two or more ester or ether groups independently attached to a C₈-C₂₂ alkyl or alkenyl chain.

The oily sugar derivatives of the invention is also referred to herein as “derivative-CP” and “derivative-RS” dependant upon whether the derivative is the product derived from a cyclic polyol or from a reduced saccharide starting material respectively.

Preferably the derivative-CP and derivative-RS contain 35% by weight tri or higher esters, eg at least 40%.

Preferably 35 to 85% most preferably 40 to 80%, even more preferably 45 to 75%, such as 45 to 70% of the hydroxyl groups in said cyclic polyol or in said reduced saccharide are esterified or etherified to produce the derivative-CPE and derivative-RSE respectively.

For the derivative-CP and derivative-RS, the tetra, penta etc prefixes only indicate the average degrees of esterification or etherification. The compounds exist as a mixture of materials ranging from the monoester to the fully esterified ester. It is the average degree of esterification as determined by weight that is referred to herein.

The derivative-CP and derivative-RS used do not have any substantial crystalline character at 20° C. Instead they are preferably in a liquid or soft solid state, as hereinbelow defined, at 20° C.

The starting cyclic polyol or reduced saccharide material is esterified or etherified with C₈-C₂₂ alkyl or alkenyl chains to the appropriate extent of esterication or etherification so that the derivatives are in the requisite liquid or soft solid state. These chains may contain unsaturation, branching or mixed chain lengths.

Typically the derivative-CP and derivative-RS has 3 or more, preferably 4 or more, for example 3 to 8, eg 3 to 5, ester or ether groups or mixtures thereof. It is preferred if two or more of the ester or ether groups of the derivative-CP and derivative-RS are independently of one another attached to a C₈ to C₂₂ alkyl or alkenyl chain. The alkyl or alkenyl groups may be branched or linear carbon chains.

The derivative-CPs are preferred for use as the oily sugar derivative. Inositol is a preferred cyclic polyol, and Inositol derivatives are especially preferred.

In the context of the present invention the terms derivative-CP and derivative-RS encompass all ether or ester derivatives of all forms of saccharides which fall into the above definition, which are especially preferred for use. Examples of preferred saccharides for the derivative. CP and derivative-RS to be derived from are monosaccharides and disaccharides.

Examples of monosaccharides include xylose, arabinose, galactose, fructose, sorbose and glucose. Glucose is especially preferred. An example of a reduced saccharide is sorbitan. Examples of disaccharides include maltose, lactose, cellobiose and sucrose. Sucrose is especially preferred.

If the derivative-CP is based on a disaccharide it is preferred if the disaccharide has 3 or more ester or ether groups attached to it. Examples include sucrose tri, tetra and penta esters.

Where the cyclic polyol is a reducing sugar it is advantageous if each ring of the derivative-CP has one ether group, preferably at the C₁ position. Suitable examples of such compounds include methyl glucose derivatives.

Examples of suitable derivative-CPs include esters of alkyl(poly)glucosides, in particular alkyl glucoside esters having a degree of polymerisation from 1 to 2.

The HLB of the derivative-CP and derivative-RS is typically between 1 and 3.

The derivative-CP and derivative-RS may have branched or linear alkyl or alkenyl chains (of varying degrees of branching), mixed chain lengths and/or unsaturation. Those having unsaturated and/or mixed alkyl chain lengths are preferred.

One or more of the alkyl or alkenyl chains (independently attached to the ester or ether groups) may contain at least one unsaturated bond.

For example, predominantly unsaturated fatty chains may be attached to the ester/ether groups, e.g. those attached may be derived from rape oil, cotton seed oil, soybean oil, oleic, tallow, palmitoleic, linoleic, erucic or other sources of unsaturated vegetable fatty acids.

The alkyl or alkenyl chains of the derivative-CP and derivative-RS are preferably predominantly unsaturated, for example sucrose tetratallowate, sucrose tetrarapeate, sucrose tetraoleate, sucrose tetraesters of soybean oil or cotton seed oil, cellobiose tetraoleate, sucrose trioleate, sucrose triapeate, sucrose pentaoleate, sucrose pentarapeate, sucrose hexaoleate, sucrose-hexarapeate, sucrose triesters, pentaesters and hexaesters of soybean oil or cotton seed oil, glucose trioleate, glucose tetraoleate, xylose trioleate, or sucrose tetra-, tri-, penta- or hexa-esters with any mixture of predominantly unsaturated fatty acid chains.

However some derivative-CPs and derivative-RSs can be based on polyunsaturated fatty acid derived alkyl or alkenyl chains, e.g. sucrose tetralinoleate. However, it is preferred that most, if not all of the polyunsaturation has been removed by partial hydrogenation if such polyunsaturated fatty acids are used.

The most highly preferred liquid derivative-CP and derivative-RS are any of those mentioned in the above three paragraphs but where the polyunsaturation has been removed through partial hydrogenation.

Preferably 40% or more of the chains contain an unsaturated bond, more preferably 50% or more, most preferably 60% or more e.g. 65% 95%.

Oily sugar derivatives suitable for use in the compositions include sucrose pentalaurate, sucrose tetraoleate, sucrose pentaerucate, sucrose tetraerucate, and sucrose pentaoleate. Suitable materials include some of the Ryoto series available from Mitsubishi Kagaku Foods Corporation.

The liquid or soft solid derivative-CP and derivative-RS are characterised as materials having a solid:liquid ratio of between 50:50 and 0:100 at 20° C. as determined by T₂ relaxation time NMR, preferably between 43:57 and 0:100, most preferably between 40:60 and 0:100, such as, 20:80 and 0:100. The T₂ NMR relaxation time is commonly used for characterising solid:liquid ratios in soft solid products such as fats and margarines. For the purpose of the present invention, any component of the NMR signal with a T₂ of less than 100 microsecond is considered to be a solid component and any component with T₂ greater than 100 microseconds is considered to be a liquid component.

The liquid or soft solid derivative-CPE and derivative-RSE can be prepared by a variety of methods well known to those skilled in the art. These methods include acylation of the cyclic polyol or of a reduced saccharide with an acid chloride; trans-esterification of the cyclic polyol or of a reduced saccharide material with short chain fatty acid esters in the presence of a basic catalyst (e.g. KOH); acylation of the cyclic polyol or of a reduced saccharide with an acid anhydride, and, acylation of the cyclic polyol or of a reduced saccharide with a fatty acid. Typical preparations of these materials are disclosed in U.S. Pat. No. 4,386,213 and AU 14416/88 (Procter and Gamble).

The compositions preferably comprise between 0.5%-30 wt % of the oily sugar derivatives, more preferably 0.75-20 wt %, most preferably 1-20 wt %, e.g. 1-15 wt %, based on the total weight of the composition.

The weight ratio of the softening compound: oily sugar derivatives is 30:1 to 1:1, more preferably 25:1 to 1.5:1, most preferably 20:1 to 2:1, e.g. 15:1 to 2.5:1.

If the oily sugar derivative or quaternary ammonium softening compound comprises hydrocarbyl chains formed from fatty acids or fatty acyl compounds which are unsaturated or at least partially unsaturated (e.g. having an iodine value of from 5 to 140, preferably 5 to 100, more preferably 5 to 60, most preferably 5 to 40, e.g. 5 to 25), then the cis:trans isomer weight ratio in the fatty acid/fatty acyl compound is greater than 20/80, preferably greater than 30/70, more preferably greater than 40/60, most preferably greater than 50/50, e.g. 70/30ₘ or greater. It is believed that higher cis:trans isomer weight ratios afford the compositions comprising the compound better low temperature stability and minimal odour formation.

Saturated and unsaturated fatty acids/acyl compounds may be mixed together in varying amounts to provide a compound having the desired iodine value.

Fatty acids/acyl compounds may also be hydrogenated to achieve lower iodine values.

Of course, the cis:trans isomer weight ratios can be controlled during hydrogenation by methods known in the art such as by optimal mixing, using specific catalysts and providing high H₂ availability.

Water

The compositions are aqueous and preferably contain water in an amount of at least 40% by weight, more preferably at least 50%, for example at least 60%, based on the total weight of the composition.

Optional Ingredients

Cationic Surfactant

The compositions may comprise one or more cationic surfactants which are not fabric softening agents. Preferably the cationic surfactant has a single C₈-C₂₈ alkyl or alkenyl chain, most preferably a single C₈-C₂₀ alkyl or alkenyl chain, more preferably a single C₁₀-C₁₈ alkyl or alkenyl chain.

Suitable cationic surfactants include water soluble single long-chain quaternary ammonium compounds such as cetyl trimethyl ammonium chloride, cetyl trimethyl ammonium bromide, or any of those listed in European Patent No. 258 923 (Akzo).

For example the cationic surfactant may be an alkyl tri-methylammonium methosulphate or chloride or alkyl ethoxylalkyl ammonium methosulphate or chloride. Examples include coconut pentaethoxymethyl ammonium methosulphate and derivatives in which at least two of the methyl groups on the nitrogen atom are replaced by (poly)alkoxylated groups.

Preferably, the cation in the cationic surfactant is selected from alkyl tri-methylammonium methosulphates and their derivatives, in which, at least two of the methyl groups on the nitrogen atom are replaced by (poly)alkoxylated groups.

Any suitable counter-ion may be used in the cationic surfactant. Preferred counter-ions for the cationic surfactants include halogens (especially chlorides), methosulphate, ethosulphate, tosylate, phosphate and nitrate.

The cationic surfactant may preferably present in an amount of 0.01 to 5% by weight, preferably 0.05%-3%, more preferably 0.1%-2% based on the total weight of the composition.

The composition may also contain one or more optional ingredients, selected from dyes, preservatives, antifoams, electrolytes, non-aqueous solvents, pH buffering agents, perfume carriers, fluorescers, hydrotropes, antiredeposition agents, polymeric and other thickeners, enzymes, optical brightening agents, opacifiers, anti-shrinking agents, anti-wrinkle agents, anti-spotting agents, germicides, fungicides, anti-corrosion agents, drape imparting agents, antistatic agents, sunscreens, colour care agents and ironing aids.

Especially preferred optional ingredients are antioxidants. The compositions preferably comprise one or more antioxidants to reduce malodour that may form upon storage, e.g. in an amount of 0.0001% to 1% by weight (in total). Preferably the antioxidant comprises at least one initiation inhibitor antioxidant and/or at least one propagation inhibitor as described in our co-pending application number GB 9911434.0. Mixtures of these two types of antioxidants have been found to be particularly beneficial, especially in reducing medium to long term malodour.

The compositions may also contain fatty acids, for example C₈-C₂₄ alkyl or alkenyl monocarboxylic acids, or, polymeric carboxylic acids. Preferably saturated fatty acids are used, in particular, hardened tallow C₁₆-C₁₈ fatty acids.

It may be advantageous if a viscosity control agent is present in the liquid compositions. Any viscosity control agent conventionally used with rinse conditioners is suitable for use with the present invention.

Synthetic polymers are useful viscosity control agents e.g. polyacrylic acid, poly vinyl pyrrolidone, polyethylene, carbomers, cross linked polyacrylamides such as ACOSOL® 880/882 polyethylene and polyethylene glycols.

The viscosity control agents may incorporated to achieve a viscosity for the final composition that is desired by the consumer. The presence of these agents may also help to improve the stability of the compositions, for example by slowing down, or stopping, the tendency of the composition to separate.

Other polymers may also be included in the compositions. Suitable polymers include cationic and nonionic polymers.

Suitable cationic polymers include cationic guar polymers such as; the JAGUAR® series of polymers (ex Rhodia), cationic cellulose derivatives such as CELQUATS®, (ex National Starch), UCARE® polymers (ex Amerchol), cationic starches such as SOFTGELS®, eg BDA CS and BD (both ex Avebe), and the C* bond polymers from Cerestar, and AMYLOFAX® and SOLVITOSE® polymers (both ex Avebe), cationic polyacrylamides such as PCG (ex Allied Colloids), FLOCAID® series of polymers (ex National Starch) and cationic chitosan derivatives.

Deflocculating polymers as described in EP 415 698 and EP 458 599 may also be included.

Suitable nonionic polymers include PLURONICS® (ex BASF), dialkyl PEGs, cellulose derivatives as described in GB 213 730 (Unilever), hydroxy ethyl cellulose, starch, and hydrohobically modified nonionic polyols such as ACUSOL® 880/882 (ex Rohm & Haas).

Mixtures of any of the aforementioned polymers may be used.

The polymer may be present in the compositions in an amount of 0.01-5% by weight based upon the total weight of the composition, more preferably 0.02-2.5%, such as 0.05-2%.

Product Form

The compositions produced by the method of the invention are in a gel or liquid form. Liquids, especially rinse conditioners having an emulsion component, are preferred.

Composition pH

The compositions of the invention preferably have a pH from 1.5 to 7, more preferably from 1.5 to 5.

Method of Treating Fabrics

The invention also provides a method of treating fabrics by applying thereto the composition produced by the methods described above. The compositions can by applied to the fabric by any suitable method. The preferred methods are by treatment of the fabric during a domestic laundering process such as by soaking, or, in the rinse cycle of a domestic washing machine.

### EXAMPLES

The invention is further illustrated by the following non-limiting examples. Further examples within the scope of the present invention will be apparent to the man skilled in the art.

All percentages in the following examples are by weight based upon the total weight of the composition and refer to the amount of the raw material added unless otherwise stated. The examples according to the invention are denoted by numbers. The comparative examples are-denoted by letters.

Comparative example A is a commercially available fabric, conditioner composition which comprises approximately 13.5 wt % of an ester-linked quaternary ammonium fabric softening compound. It was made by melting together an ester-linked quaternary ammonium fabric softening compound, a nonionic surfactant, and a cationic surfactant and adding this co-melted mixture to hot water.

For Example 1 the oily sugar derivative was added in addition to the cationic softener (1). The Example was prepared by mixing the oily sugar derivative and the perfume together to form a pre-mix. The cationic softener, the nonionic surfactant and the cationic surfactant were separately melted together and this melted mixture was added to the oily sugar derivative mixture.

For Example 2 the oily sugar derivative has been added in place of the equivalent amount of the ester-linked quaternary ammonium compound when compared to example 1. The example was prepared by pre-mixing the oily sugar derivative with the water prior to addition of a molten mixture of the cationic softener with the nonionic surfactant and cationic surfactant.

For example 3 the oily sugar derivative and cationic softener were co-melted and perfume was added to the co-melt. At 55° C., water and the nonionic surfactant were added of under high shear. The mixture was then allowed to cool.

Examples 4 to 6 were prepared by heating water to 75° C., adding a mixture of the oily sugar derivative and nonionic surfactant to the water, stirring or shearing the composition to obtain a homogenous mixture, adding the cationic softener with further stirring or shearing, adding the tallow alcohol (example 5 only), cooling the mixture to 50° C., adding perfume and (example 4 only) thickening polymer under stirring or shearing and allowing the mixture to cool so as to obtain a homogeneous mixture.

| | 1 | 2 | 3 | 4 | 5 | 6 |
|---|---|---|---|---|---|---|
| Cationic softener (1) | — | — | — | — | — | 9.75% |
| Cationic softener (2) | 17.2% | 13.4% | — | 3.38% | 9.75% | — |
| Cationic softener (3) | — | — | 12.2% | — | — | — |
| Coconut alcohol 20 EO (4) | 0.75% | 0.75% | — | 0.1% | 0.7% | 0.75% |
| Coconut alcohol 20 EO (5) | — | — | 2.5% | — | — | — |
| Hardened tallow fatty | 0.75% | 0.75% | — | — | — | — |
| acid (6) | | | | | | |
| Tallow alcohol | — | — | — | — | 0.7% | — |
| Perfume | 0.9% | 0.9% | 1% | 0.32% | 0.95% | 0.96% |
| Oily sugar derivative (7) | 1.0% | 3.0% | 12.2% | 1.13% | 3.25% | 3.25% |
| Thickening polymer (8) | — | — | — | 0.07% | — | — |
| Water | To 100% | To 100% | To 100% | To 100% | To 100% | To 100% |

(1) N,N-di(hardened tallowoyloxyethyl)-N-hydroxyethyl-N-methyl ammonium sulphate, available as Tetranyl AHT 1 from Kao.
(2) 1, 2 bis [hardened tallowoyloxy]-3-trimethylammonium propane chloride available from Clariant.
(3) N,N-bis(acyloxyethyl)-N,N-dimethyl ammonium chloride (DEEDMAC) available from Akzo.
(4) available as Genapol C200 from Clariant.
(5) available as Genapol C150 from Clariant.
(6) available as Laurex CS from Albright & Wilson.
(7) sucrose tetraerucate, available as Ryoto ER290 from Mitsubishi Kagaku Foods Corporation.
(8) hydroxyl ethyl cellulose, available as Natrosol Plus 331 from Aqualon.

Storage stability was measured by monitoring the viscosity of the example upon storage at different temperature conditions as detailed below. The viscosities are measured at room temperature using a Haake RV20 viscometer with a shear rate of 106s⁻¹. The units in the table are given in mPa.s.

TABLE 1
viscosity stability upon storage at 0° C.

| | 0 | 14 | 21 | 28 | 42 | 56 | 63 | 84 |
|---|---|---|---|---|---|---|---|---|
| Example | days | days | days | days | days | days | days | days |
| 4 | 45 | — | 47 | — | 47 | — | 49 | 46 |
| 5 | 50 | 48 | — | 49 | 47 | 47 | — | — |

TABLE 2
viscosity stability upon storage at 5° C.

| Exam- | 0 | 7 | 14 | 21 | 28 | 42 | 56 | 63 | 84 |
|---|---|---|---|---|---|---|---|---|---|
| ple | days | days | days | days | days | days | days | days | days |
| Com- | 50 | 36 | 31 | — | 28 | 36 | — | 39 | 42 |
| para- | | | | | | | | | |
| tive A | | | | | | | | | |
| 1 | 43 | 43 | 38 | — | 38 | 37 | — | 43 | 58 |
| 2 | 80 | 67 | 70 | — | 62 | 67 | — | 69 | 78 |
| 4 | 45 | — | — | 42 | — | 43 | — | 42 | 39 |
| 5 | 50 | — | 53 | — | 58 | 53 | 52 | — | — |
| 6 | 72 | 72 | 73 | — | 69 | — | — | — | — |

TABLE 3
viscosity stability upon storage at 20° C.

| Exam- | 0 | 7 | 14 | 22 | 28 | 42 | 57 | 63 | 84 |
|---|---|---|---|---|---|---|---|---|---|
| ple | days | days | days | days | days | days | days | days | days |
| Com- | 50 | 44 | 39 | — | 30 | 28 | — | 33 | 41 |
| para- | | | | | | | | | |
| tive A | | | | | | | | | |
| 1 | 43 | 44 | 41 | — | 34 | 28 | — | 32 | 40 |
| 2 | 80 | 81 | 73 | — | 63 | 62 | — | 70 | 68 |
| 3 | 210 | 290 | 270 | 288 | — | — | 230 | — | 260 |
| 4 | 45 | — | — | 40 | — | 38 | — | 47 | 48 |
| 5 | 50 | — | 52 | — | 55 | 48 | 52 | — | — |
| 6 | 72 | 78 | 76 | — | 73 | — | — | — | — |

TABLE 4
viscosity stability upon storage at 37° C.

| Exam- | 0 | 7 | 14 | 21 | 28 | 42 | 56 | 63 | 84 |
|---|---|---|---|---|---|---|---|---|---|
| ple | days | days | days | days | days | days | days | days | days |
| Com- | 50 | 56 | 296 | — | Gell | Gell | — | Gell | Gell |
| para- | | | | | ed | ed | | ed | ed |
| tive A | | | | | | | | | |
| 1 | 43 | 41 | 34 | — | 29 | 21 | — | 25 | 27 |
| 2 | 80 | 77 | 74 | — | 63 | 60 | — | 53 | 58 |
| 4 | 45 | — | — | 46 | — | 53 | — | 60 | 98 |
| 5 | 50 | — | 56 | — | 52 | 51 | 52 | — | — |
| 6 | 72 | 87 | 88 | — | 88 | — | — | — | — |

TABLE 5
viscosity stability upon storage at 45° C.

| Exam- | 0 | 7 | 14 | 21 | 28 | 42 | 57 | 63 |
|---|---|---|---|---|---|---|---|---|
| ple | days | days | days | days | days | days | days | days |
| 3 | 210 | 238 | 272 | 310 | — | — | 290 | — |
| 4 | 45 | — | — | 50 | — | 68 | — | 102 |
| 5 | 50 | — | 51 | — | 48 | 47 | 105 | — |
| 6 | 72 | 106 | 106 | — | 99 | — | — | — |

B. Softening Performance

The softening performance of the examples was evaluated by adding 0.74 g of the example 1 and 0.69 g of example 2 (equivalent to 2 ml of a 5 wt % dispersion) to 1 liter of tap water, at ambient temperature in a tergotometer. One ml of a 1 wt % alkyl benzene sulphonate, per 1 liter of tergotometer pot water, was added to simulate anionic surfactant carried over from the main wash.

Three pieces of terry towelling (20 cm×20 cm, 40 g total weight) were added to the tergotometer pot. The cloths were rinsed for 5 minutes at 65 rpm, spin dried to remove excess liquor and line dried overnight and conditioned at 21° C. and 65% relative humidity for 24 hours.

Softening of the fabrics was assessed by an expert panel of 4 people using a round robin paired comparison test protocol. Each panel member assessed four sets of test cloths. Each set of test cloths contained one cloth of each test system under evaluation. Panel members were asked to assess softness on an 8 point scale. Softness scores were calculated using an “Analysis of Variance” technique. Lower values indicate better softening as assessed by the panellists.

The softening scores are given below;

| Example | Softness score |
|---|---|
| 1 | 3.7 |
| 2 | 4.2 |
| Comparative Example A | 3.4 |

The above results demonstrate that the softening performance is not changed to a substantial extent by the replacement of some of the ester-linked quaternary ammonium compound with the oily sugar derivative and stablilisation upon storage at elevated temperatures is improved.

1. A method of improving the viscosity stability upon storage of a fabric softening composition comprising:
(a) 0.5% to 30% by weight of at least one ester-linked quaternary ammonium fabric softening compound,
(b) perfume, and
(c) an alkoxylated nonionic surfactant
by the inclusion in the composition of at least one oily sugar derivative in a weight ratio of softening compound to sugar derivative in the range 30:1 to 1:1.

2. A method according to claim 1 wherein the weight ratio of the softening compound to sugar derivative is in the range 25:1 to 1:1.

3. A method according to either claim 1 wherein the softening compound and/or the oily sugar derivative is/are separately mixed with another active component of the fabric softening composition to form a pre-mixture prior to the admixing of the softening compound with the oily sugar derivative.

4. A method according to claim 3 wherein the active component is a cationic surfactant having a single C₈-C₂₈ alkyl or alkenyl chain, a nonionic surfactant or a perfume.

5. A method according to claim 4, wherein the oily sugar derivative is pre-mixed with water and/or with at least one cationic surfactant having a single C₈-C₂₈ alkyl or alkenyl chain and/or a nonionic surfactant to form a pre-mixture and subsequently the softening compound, in at least partially liquid or molten state, is mixed with said pre-mixture.

6. A method according to claim 3 wherein the softening compound is pre-mixed with water and/or with at least one cationic surfactant having a single C₈-C₂₈ alkyl or alkenyl chain, and/or a nonionic surfactant, to form a pre-mixture and subsequently the oily sugar derivative is mixed with said pre-mixture.

7. A method according to claim 1, wherein the composition comprises between 8% wt-20% wt of the softening compound, based on the total weight of the composition.

8. A method according to claim 1 wherein the oily sugar derivative is a liquid or soft solid derivative of a cyclic polyol or of a reduced saccharide, said derivative resulting from 35 to 100% of the hydroxyl groups in said polyol or in said saccharide being esterified or etherified, and wherein, the oily sugar derivative has two or more ester or ether groups independently attached to a C₈-C₂₂ alkyl or alkenyl chain.

9. A method according to claim 8, wherein the oily sugar derivative is a liquid or soft solid derivative of a cyclic polyol or of a reduced saccharide resulting from 40-80%, preferably 45-75% of the hydroxyl groups in said polyol or in said saccharide being esterified or etherified.

10. A method according to claim 1, wherein the oily sugar derivative is derived from a monosaccharide or disaccharide.

11. A method according to claim 4 wherein the cationic surfactant is present in an amount of 0.01 to 5% by weight, preferably 0.1% to 2% based on the total weight of the composition.

12. A method according to claim 4 wherein the alkoxylated nonionic surfactant is an ethoxylated surfactant, preferably present in an amount of 0.01 to 5% by weight, preferably 0.1% to 2% based on the total weight of the composition.

13. A fabric softening composition produced by the method of any one of claims 1.

14. A method of treating fabric by applying thereto the composition of claim 13.

15. The use of an oily sugar derivative as defined in any one of claim 8, to provide viscosity stability at 37° C. to a fabric softening composition comprising 0.5% to 30% by weight of at least one ester-linked quaternary ammonium fabric softening compound, a perfume and an alkoxylated nonionic surfactant.
